(19) United States
(12) Patent Application Publication
(10) Pub. No.: US 2023/0365298 A1
(43) Pub. Date: Nov. 16, 2023

(54) ASSEMBLY FOR BOX

(71) Applicant: idic Inc., Incheon (KR)

(72) Inventor: Eunha Kim, Seoul (KR)

(21) Appl. No.: 18/056,594

(22) Filed: Nov. 17, 2022

(30) Foreign Application Priority Data
May 16, 2022 (KR) 10-2022-0059299

(51) Int. Cl. B65D 6/24; B65D 21/02

(52) U.S. Cl. CPC B65D 11/1873; B65D 21/0215

(57) ABSTRACT

Proposed is an assembly for box to be provided for exhibition, storage etc, the assembly for box having a coupling structure of a plurality of rectangular panels using holders, top caps, and front caps for users to quickly and easily assemble and disassemble boxes directly on sites.

### CROSS REFERENCE TO RELATED APPLICATION

The present application claims priority to Korean Patent Application No. 10-2022-0059299, filed on May 16, 2022, the entire contents of which is incorporated herein for all purposes by this reference.

### BACKGROUND OF THE INVENTION

### Field of the Invention

The present invention relates to an assembly for box where the box is provided for exhibition, storage etc and more particularly to an assembly for box for users to quickly and easily assemble on sites.

### Description of the Related Art

Conventionally, a box like a transparent box which is made for storage or exhibition of products is made to form a structure by making holes or putting adhesives on the panels. Therefore, users has no choice but to rely on customization. Also, it is difficult to use the manufactured box for other purposes or uses because it cannot be disassembled or is inappropriate to be disassembled.

In terms of the transportation of the box, there is a risk of damage as well as a burden of transportation costs due to a large volume it takes. The high cost of customizing is also a problem.

### SUMMARY OF THE INVENTION

Accordingly, the present disclosure has been made keeping in mind the above problems occurring in the related art, and the objective of the present disclosure is to provide an assembly for box which enables all the manufacturing processes of the box to be implemented by using the square panel as it is and by the consumers themselves so that it can achieve productivity improvement, production cost reduction, transportation cost reduction through significant reduction of transport volume, and furthermore, cost reduction in displaying goods.

In order to achieve the above objective, the present disclosure provides an assembly for box comprising: rectangular front panels, side panels and cover panels; a holder having a base plate with vertical screw holes on the bottom, a number of split blocks formed by splitting one block protruding from the base plate to a certain height by one longitudinal groove extending in the longitudinal direction and a number of intersecting grooves intersecting the longitudinal groove in the transverse direction, and a horizontal screw hole formed by penetrating in the transverse direction at least one of the split blocks which is formed on one side of the longitudinal groove; a top cap having a cap plate stacked on and detachably fastened to the bottom of the base plate through a through hole which is formed corresponding to the vertical screw hole, and an ‘L’ protruding step protruding on the cap plate to a height as high as the thickness of the cover panel; and a front cap having a panel support surface part which is detachably coupled to one longitudinal end of the holder and protrudes from the holder in the transverse direction, wherein one end part of the side panel can be fixed to the holder by means of a screw fastened through the horizontal screw hole while being inserted into the longitudinal groove of the holder, one end part of the front panel can be fixed to the holder by being attached to the panel support surface part of the front cap coupled to the one longitudinal end of the holder while being inserted into one of the plurality of transverse grooves of the holder and vertically contacting the side panel, and one corner part of the cover panel can be fixed to the holder by a screw fastened to the vertical screw hole through the through hole while it is supported by the ‘L’ protruding step of the top cap to be inserted between the top cap and the base plate of the holder so that it is in vertical contact with the side panel and the front panel respectively.

According to the present disclosure as describe above, a box can be assembled with rectangular panels, holders, top caps and front caps without putting adhesive or making holes on the panels. The assembled box can be disassembled and reassembled.

Also, instead of the transportation of the boxes, the assembly is transported and assembled by the user on sites, so that it can greatly reduce the volume of the transportation. Accordingly, it can be a factor of great cost reduction, especially when it is to be installed as a showcase for overseas exhibition halls.

In addition, since the panel only needs to be cut into a square, manufacturing to make a hole or a special shape is unnecessary, so there is a great manufacturing cost reduction effect.

Furthermore, various advantageous structures can be made by stacking multiple assembled boxes, it is possible to expand the scope of use of the box by using it as a module.

According to an aspect of the present disclosure, a sunken step is formed on the entire plate surface except for the edge of the cap plate, a foot tape having a thickness corresponding to twice that of the sunken step is detachably attached to the sunken step, so that the top cap can be seated on the ground through the foot tape or can be stacked on the sunken step of another inverted top cap through the foot tape.

According to an aspect of the present disclosure, the assembly for box further comprises a gap finishing member which can be detachably inserted along a corner between the side panel and the cover panel or between the front panel and the cover panel, which are vertically facing each other by the holder.

According to an aspect of the present disclosure, the assembly for box further comprises a rectangular panel for installing a light device, wherein, in the inner space formed by fixing the front panel, the side panel, and the cover panel to the holder, one end part of the panel for installing the light device can be inserted into one of the intersecting grooves so that the panel for installing the light device is installed parallel to the front panel.

According to an aspect of the present disclosure, a double-sided foam tape is attached to the panel support surface part of the front cap, so that one end part of the front panel is attached to the panel support surface part through the foam tape.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 shows a perspective view and six-sided views of a holder, which is one component of an assembly for box according to an embodiment of the present invention,

FIG. 2 shows a perspective view for explaining an exemplary use of the holder of FIG. 1,

FIG. 3 shows a perspective view for explaining a panel fixing method using the holder of FIG. 1,

FIG. 4 shows a perspective view of the upper and lower sides of a top cap, which is one component of the assembly for box according to the embodiment of the present invention,

FIGS. 5a and 5b show sequential perspective views for explaining an exemplary use of the top cap of FIG. 4,

FIG. 6 and FIG. 7 show cross-sectional views for explaining the coupling structure of the holder and the top cap,

FIGS. 8a and 8b show sequential perspective views for explaining the use of a foot tape, which is a component of the assembly for box according to the embodiment of the present invention,

FIG. 9 shows a perspective view of the box assembled using the holder and the top cap,

FIG. 10 and FIG. 11 show a partially enlarged perspective view and an overall perspective view of the box for explaining the use of the gap finishing member, which is one component of the assembly for box according to the embodiment of the present invention,

FIG. 12 shows a perspective view of a front cap that is a component of the assembly for box according to the embodiment of the present invention,

FIGS. 13a and 13b show sequential perspective views for explaining the use of the front cap of FIG. 12,

FIG. 14 shows a perspective view of the box assembled using the holder, the top cap, the gap finishing member, and the front cap,

FIG. 15 shows a perspective view of a panel for installing a lighting device additionally applied to the box of FIG. 14,

FIG. 16 shows a perspective view of a plurality of the boxes of FIG. 14 stacked thereon, and

FIG. 17 shows a partially enlarged view for explaining the stacked coupling structure between the boxes of FIG. 16.

### DETAILED DESCRIPTION OF THE INVENTION

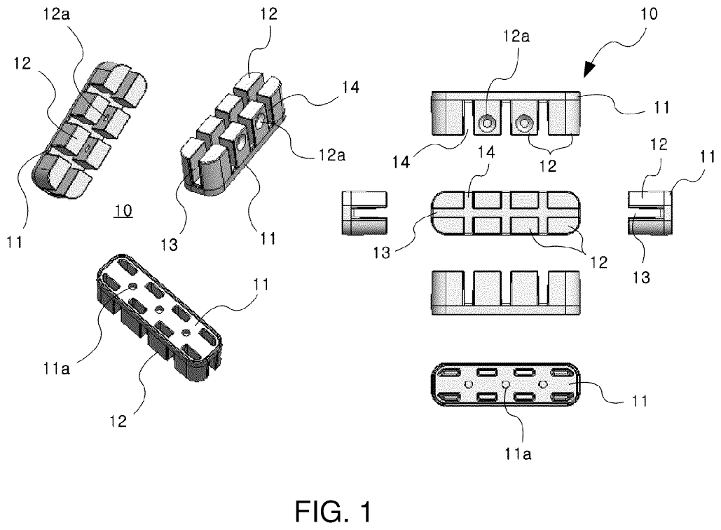

The assembly for box according to the embodiment of the present invention includes a holder 10 as shown in FIG. 1.

The holder 10 has a base plate 11 and a plurality of split blocks 12 protruding to a predetermined height on an upper surface of the base plate 11. A plurality of vertical screw holes 11a are formed on the bottom surface of the base plate 11.

A plurality of the split blocks 12 can be provided because one big block protruding from the base plate 11 to a certain height is split up by one longitudinal groove 13 extending in the longitudinal direction and a number of intersecting grooves 14 intersecting the longitudinal groove 13 in the transverse direction.

Horizontal screw holes 12a are formed in the transverse direction through a plurality of split blocks 12 located on one side of the longitudinal groove 13.

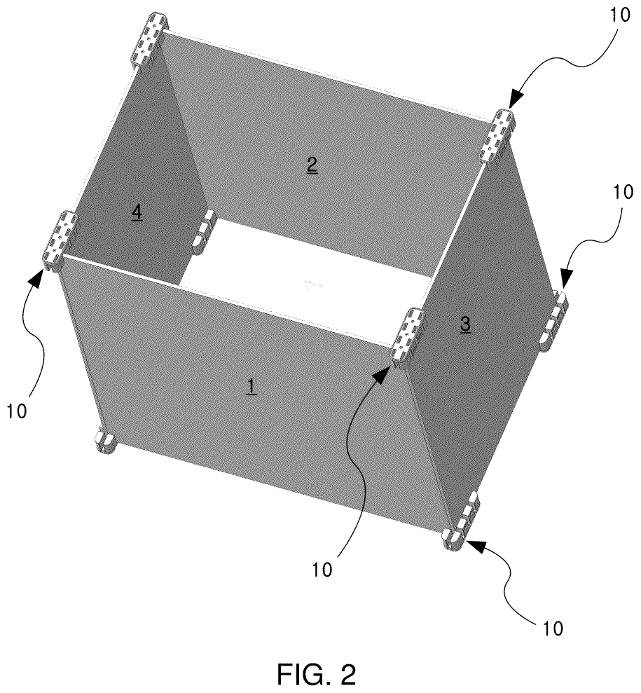

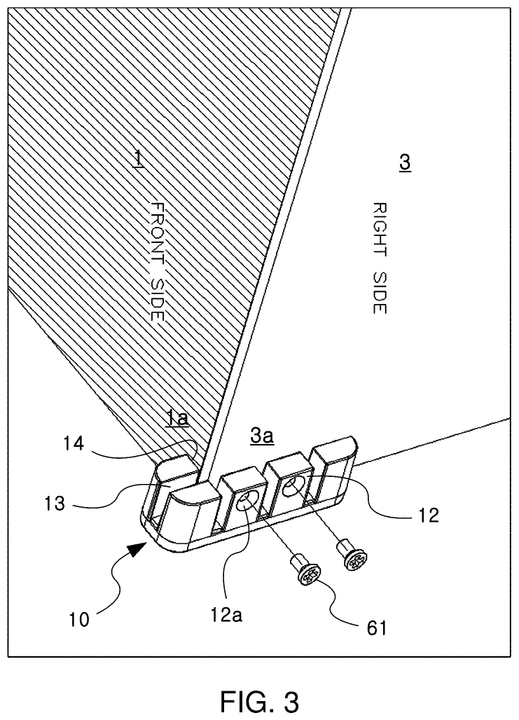

According to the holder 10 with such configurations, as shown in FIG. 2, corners can meet between rectangular front panels 1, 2 and side panels 3, 4 and be vertically coupled. That is, as shown in FIG. 3, a screw 61 is fastened through the horizontal screw hole 12a of the split block 12 with one end 3a of the side panel 3 inserted into the longitudinal groove 13 of the holder 10, so that the side panel 3 is fixed to the holder 10. In addition, one end 1a of the front panel 1 is inserted into the intersecting groove 14 of the holder 10 to keep it in vertical contact with the side panel 3.

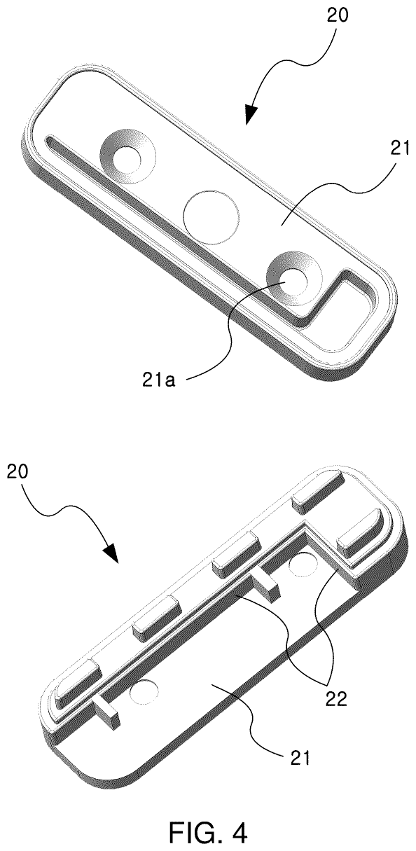

The assembly for box according to the embodiment of the present invention includes a top cap 20 as shown in FIG. 4. The top cap 20 has a cap plate 21 and an ‘L’ protruding step 22 protruding on the surface thereof to a height as high as the thickness of the panel.

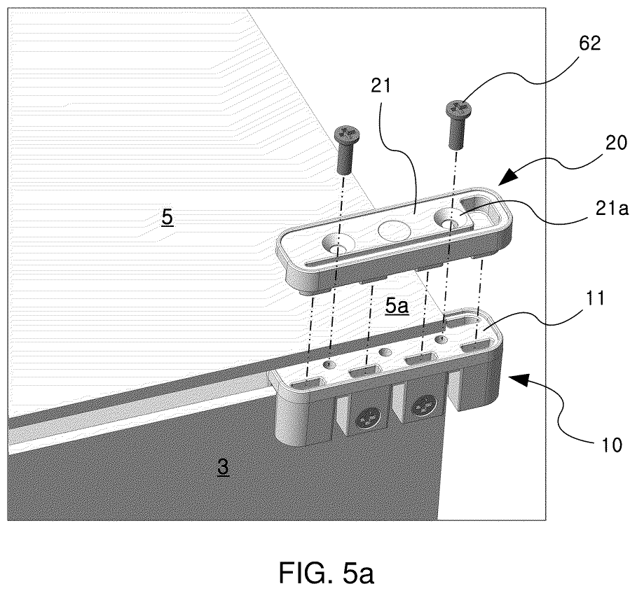

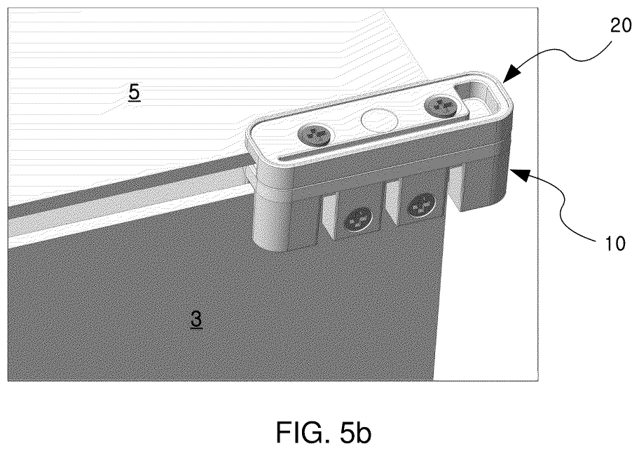

As shown in FIGS. 5a and 5b, the top cap 20 is a configuration for fixing the cover panel 5 by stacking and coupling on the base plate 11 of the holder 10. The cover panel 5 is located between the base plate 11 of the holder 10 and the cap plate 21 of the top cap 20 in a state where one corner 5a is supported by contact with the ‘L’ protruding step 22. A plurality of vertical screw holes 21a are formed through the cap plate 21, so that the cover panel 5 is fixed through the hole 21a to the holder 10 by a screw 62, which is then fastened to the vertical screw hole 11a of the base plate 11.

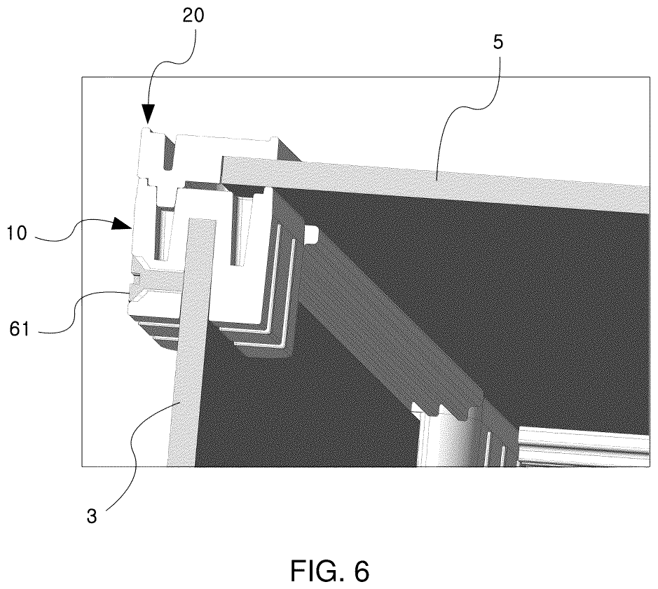

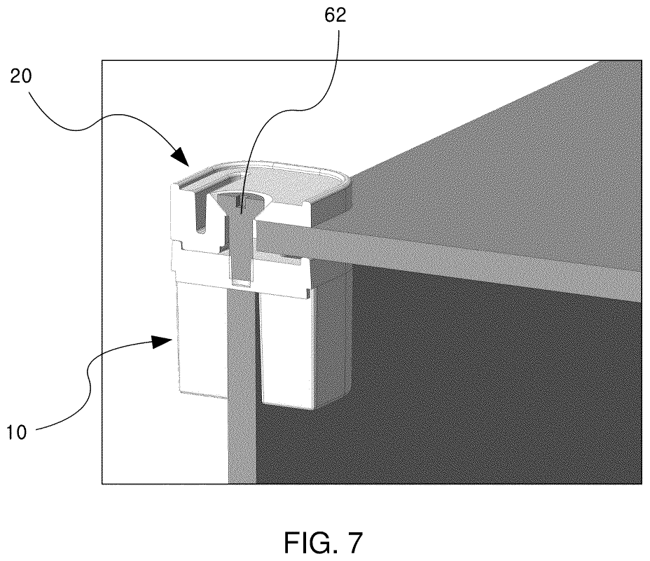

The cover panel 5 fixed in this way is shown in FIG. 6 which shows the holder 10 and the top cap 20 can be coupled to each other in a congruent manner through a vertically male and female coupling. FIG. 6 also shows the side panel 3 fixed to the holder 10 by fastening the screw 61. FIG. 7 shows the top cap 20 coupled to the holder 10 by the fastened screw 62.

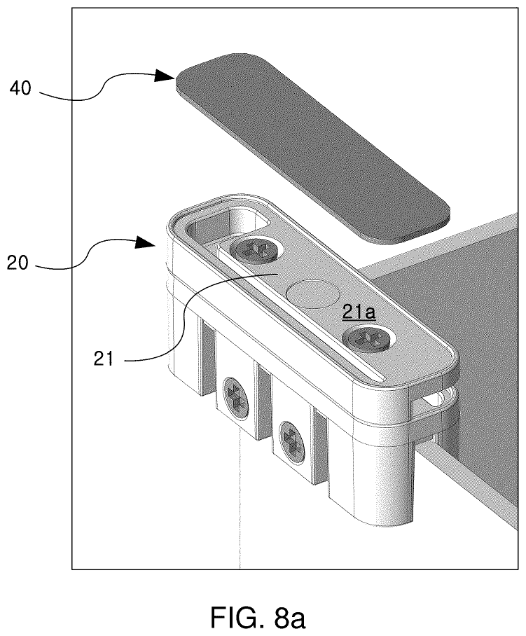

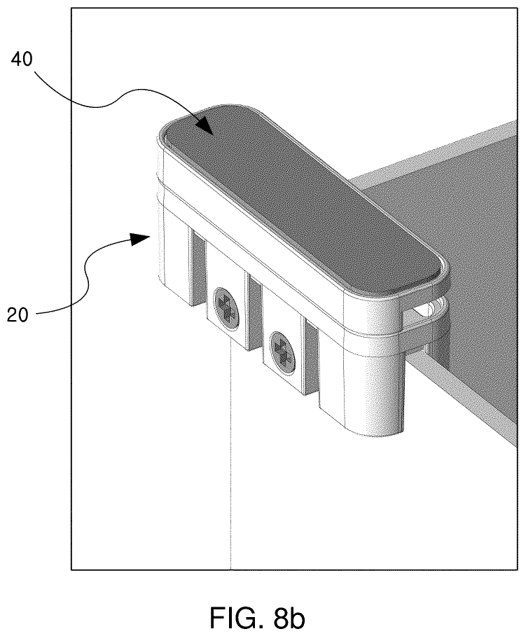

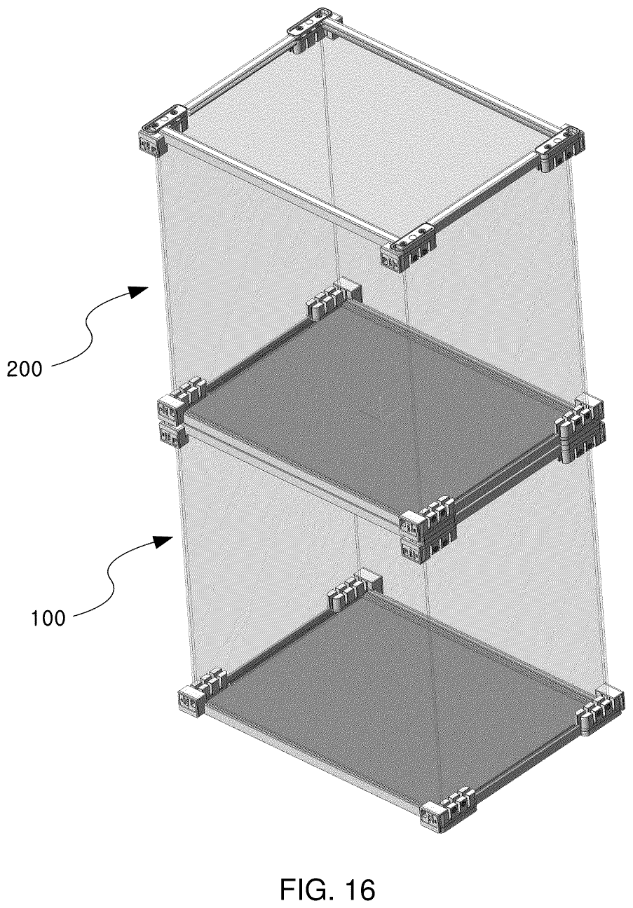

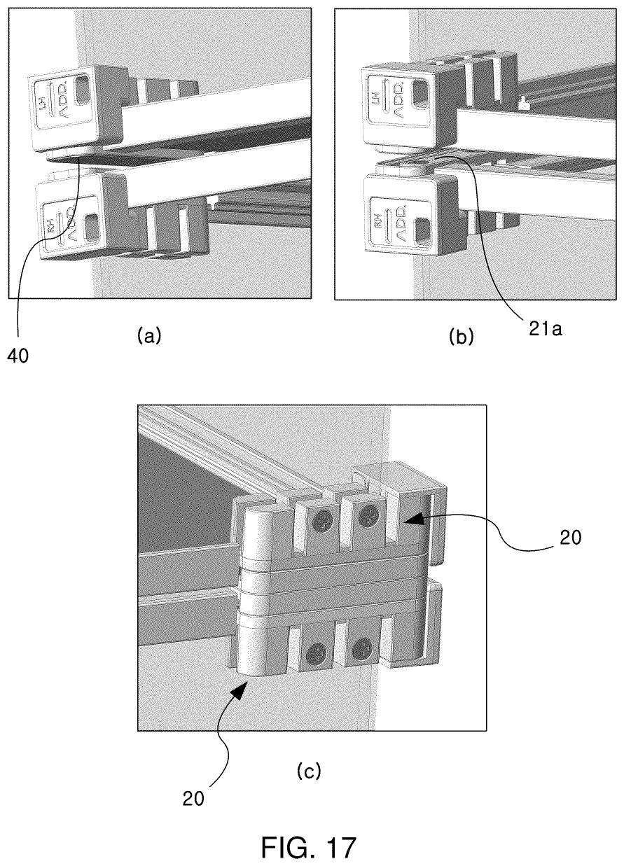

As illustrated in FIGS. 8a and 8b, the top cap 20 has a sunken step 21a formed in the entire plate surface excluding the edge of the cap plate 21. A foot tape 40 having a thickness corresponding to twice that of the step is attached to the sunken step 21a. With this, the assembled box may be seated on the ground by allowing the foot tape 40 to contact the ground. Also, as illustrated in FIGS. 16 and 17, when the boxes 100 and 200 are stacked, the foot tape 40 is completely inserted and coupled between the sunken steps 21a which respectively belong to the cap plates 21 of the top caps 20 facing each other vertically and reversely, so that it allows a stable stacking structure to be maintained.

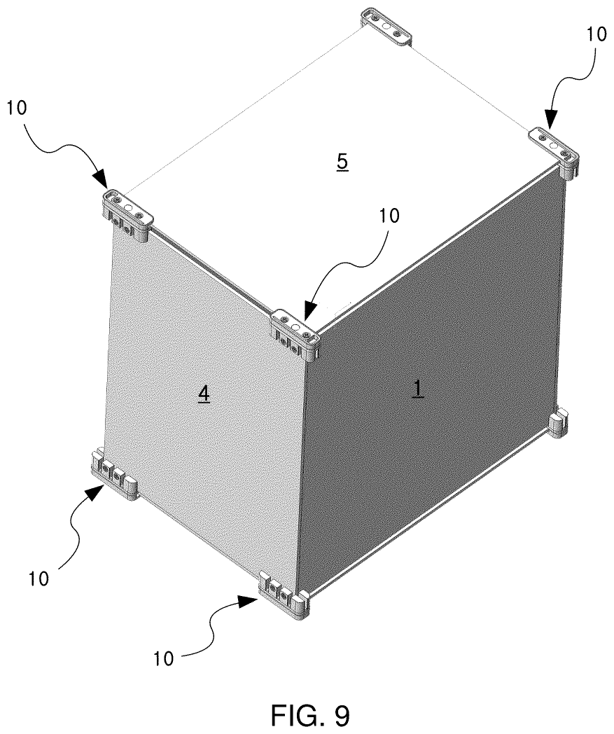

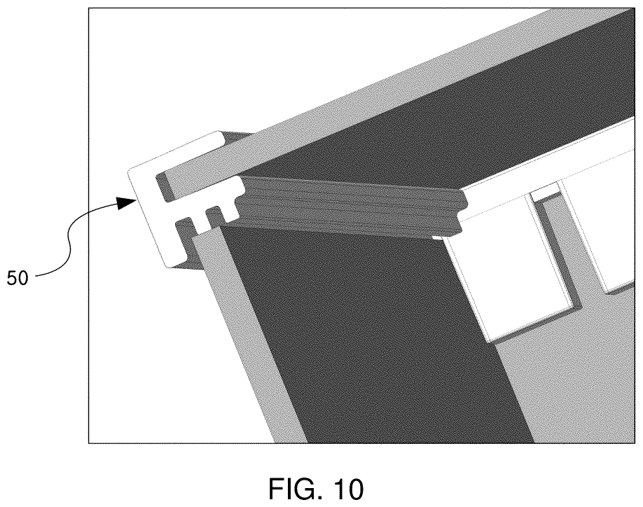

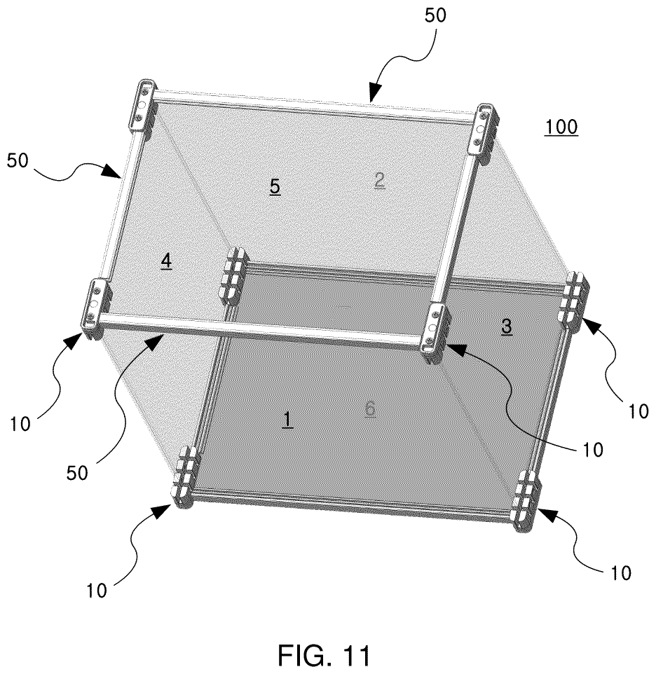

After the front and rear front panels 1, left and right side panels 4 and the upper and lower cover panels 5 are combined as shown in FIG. 9, the gap finishing members 50 are inserted along the corners formed between the side panels 4 and the cover panels 5 vertically facing each other by the holders 10, and also along the corners between the front panels 1 and the cover panels 5 as shown in FIGS. 10 and 11.

However, even when the gap finishing members 50 are installed, it is not possible to prevent the front and rear panels 1, 2 from separating from the left and right side panels 3, 4, specifically the front panels 1, 2 from the holders 10.

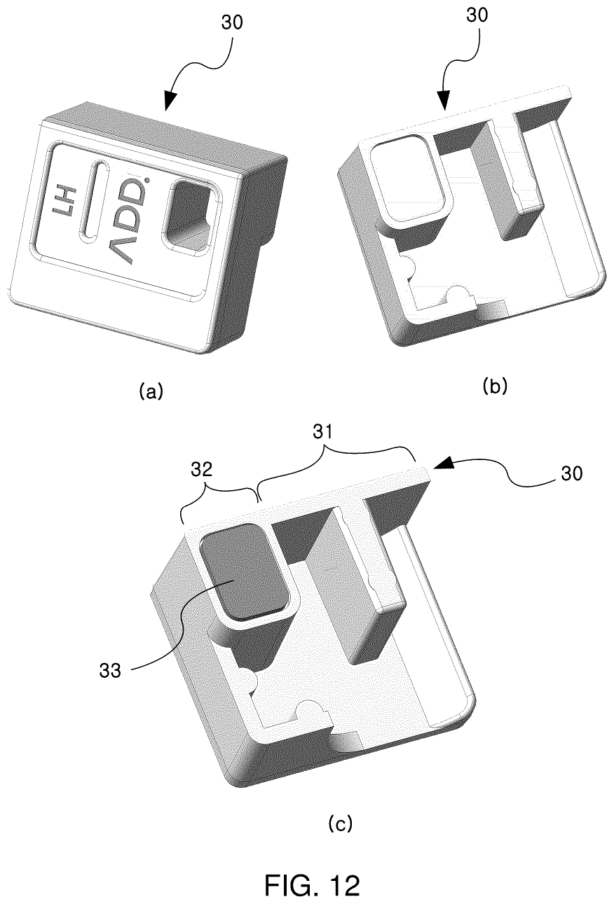

To solve this, the assembly for box according to the embodiment of the present invention further includes a front cap 30 as shown in FIG. 12.

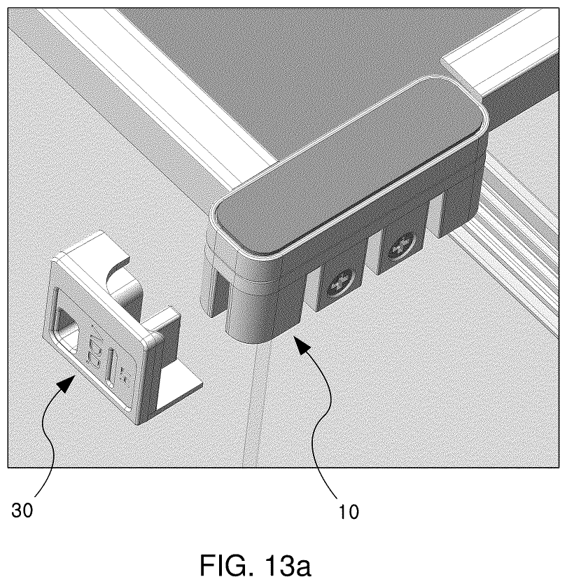

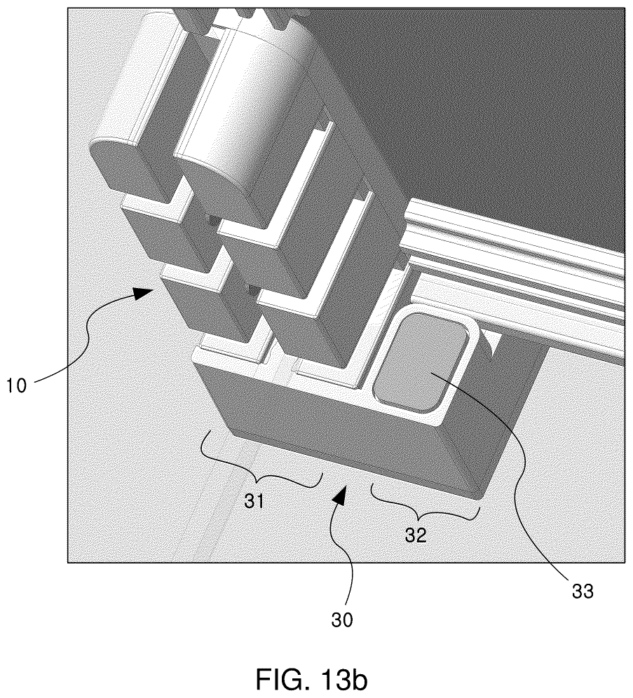

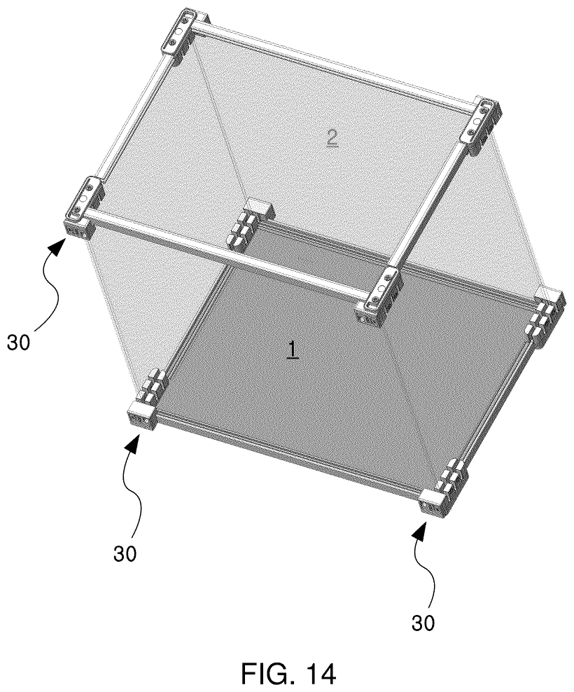

The front cap 30 is divided into a coupling part 31 at one part and a panel support surface part 32 at the other part. As shown in FIGS. 13a and 13b, the coupling part 31 is coincidentally coupled to one longitudinal end part of the holder 10. With this, the panel support surface part 32 protrudes in the transverse direction from the holder 10, so that it can be attached to one end of the front panel 1 or 2 as shown in FIG. 14. The attachment is mediated by a foam tape 33, a type of double-sided tape attached on the panel support surface part 32 as illustrated in FIG. 12.

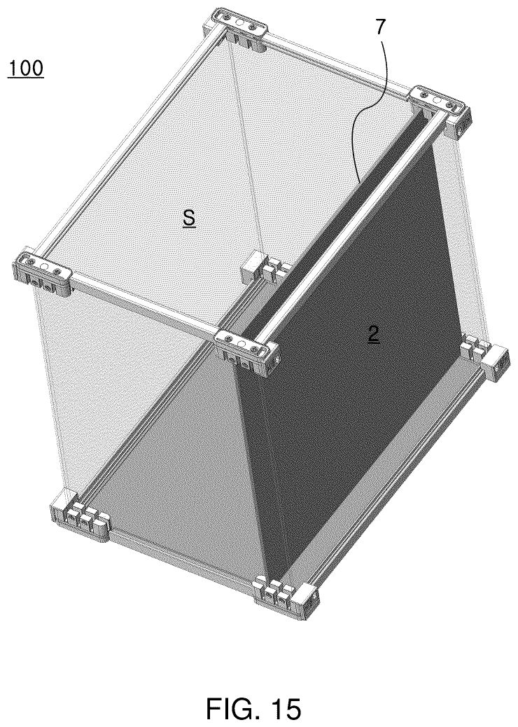

Meanwhile, as shown in FIG. 15, a panel 7 for installing a lighting device may be further installed in the inner space of the box 100 at a predetermined interval from the front panel 2. The panel 7 can be installed by selecting one of the remaining intersecting grooves 14 in which the front panel 2 is not inserted, as shown in FIGS. 1 and 3. Various lighting devices and wires can be stored in the space obtained between the lighting installation panel 7 and the front panel 2, so that indirect lighting may be provided to a display space S for an article located in the front side of the panel 7.

In addition, the boxes 100 and 200 assembled as described above may be stacked in two or more as shown in FIG. 16. The stacking structure in this case is the same as described in FIG. 17 and as described above with respect to the foot tape 40 of FIGS. 8a and 8b.

Meanwhile, the assembly for box described above is only an embodiment for helping the understanding of the present disclosure, so the scope of the present disclosure defined by the claims to be described below should not be limited by the above description.

What is claimed is:

1. An assembly for box comprising:
Rectangular front panels, side panels and cover panels;
a holder having a base plate with vertical screw holes on the bottom, a number of split blocks formed by splitting one block protruding from the base plate to a certain height by one longitudinal groove extending in the longitudinal direction and a number of intersecting grooves intersecting the longitudinal groove in the transverse direction, and a horizontal screw hole formed by penetrating in the transverse direction at least one of the split blocks which is formed on one side of the longitudinal groove;
a top cap having a cap plate stacked on and detachably fastened to the bottom of the base plate through a through hole which is formed corresponding to the vertical screw hole, and an ‘L’ protruding step protruding on the cap plate to a height as high as the thickness of the cover panel; and
a front cap having a panel support surface part which is detachably coupled to one longitudinal end of the holder and protrudes from the holder in the transverse direction,
wherein
one end part of the side panel can be fixed to the holder by means of a screw fastened through the horizontal screw hole while being inserted into the longitudinal groove of the holder,
one end part of the front panel can be fixed to the holder by being attached to the panel support surface part of the front cap coupled to the one longitudinal end of the holder while being inserted into one of the plurality of transverse grooves of the holder and vertically contacting the side panel, and
one corner part of the cover panel can be fixed to the holder by a screw fastened to the vertical screw hole through the through hole while it is supported by the ‘L’ protruding step of the top cap to be inserted between the top cap and the base plate of the holder so that it is in vertical contact with the side panel and the front panel respectively.

2. The assembly for box of claim 1, wherein a sunken step is formed on the entire plate surface except for the edge of the cap plate, a foot tape having a thickness corresponding to twice that of the sunken step is detachably attached to the sunken step, so that the top cap can be seated on the ground through the foot tape or can be stacked on the sunken step of another inverted top cap through the foot tape.

3. The assembly for box of claim 1 further comprising a gap finishing member which can be detachably inserted along a corner between the side panel and the cover panel or between the front panel and the cover panel, which are vertically facing each other by the holder.

4. The assembly for box of claim 1 further comprising a rectangular panel for installing a light device, wherein, in the inner space formed by fixing the front panel, the side panel, and the cover panel to the holder, one end part of the panel for installing the light device can be inserted into one of the intersecting grooves so that the panel for installing the light device is installed parallel to the front panel.

5. The assembly for box of claim 1, wherein a double-sided foam tape is attached to the panel support surface part of the front cap, so that one end part of the front panel is attached to the panel support surface part through the foam tape.
